(19) United States
(12) Patent Application Publication
(10) Pub. No.: US 2009/0193408 A1
(43) Pub. Date: Jul. 30, 2009

(54) INTERFACE AND METHOD FOR INTERFACING ELEMENT MANAGEMENT SERVER IN WIRELESS TELECOMMUNICATION SYSTEM

(75) Inventors: Jung-Hyun Ok, Seoul (KR); Se-Whan Ko, Seongnam-si (KR); Eun-Kyu Kim, Seoul (KR)

Correspondence Address: AMPACC LAW GROUP, 3500 188th St. SW, Lynnwood, WA, 98037, US

(73) Assignee: POSDATA CO., LTD., Seongnam-si (KR)

(21) Appl. No.: 12/373,293

(22) PCT Filed: Jul. 12, 2007
(86) PCT No.: PCT/KR2007/003396

§ 371 Date: Jan. 9, 2009

(30) Foreign Application Priority Data
Jul. 12, 2006 (KR) 10-2006-0065264

(51) Int. Cl. G06F 9/44; G06F 15/16; G06F 15/177

(52) U.S. Cl. 717/170; 709/223; 709/221; 709/220

(57) ABSTRACT

Disclosed is an interface for interfacing an element management server in a wireless telecommunication system and a method for the same. The element management server for managing an ACR and an RAS, which are elements of the wireless telecommunication system, are adapted to interwork with the ACR and the RAS, respectively, so that the server can directly manage the ACR and the RAS and, particularly, the RAS can be operated more efficiently and maintained/repaired more quickly. The element management server manages the version of a package regarding all processors of lower elements and software to be loaded, and respective processors of the lower elements store nothing but their setup information (e.g. software, version) so that, if necessary, the element management server can transmit specific software only to the lower elements. This guarantees fast software download and provides users with stable services.

### TECHNICAL FIELD

The present invention relates to an interface for interfacing an element management server in a wireless telecommunication system and a method for the same. More particularly, the present invention relates to an interface for interfacing an element management server in a wireless telecommunication system and a method for the same, wherein an element management server for managing an ACR (Access Control Router) and an RAS (Radio Access System), which are elements of the wireless telecommunication system, is adapted to interwork with the ACR and the RAS, respectively, so that the server can directly manage the ACR and the RAS and, particularly, the RAS can be operated more efficiently and maintained/repaired more quickly.

### BACKGROUND ART

Recently, various communication services (e.g. mobile communication, wireless Internet) are provided via wireless networks in line with the development of electronic/communication technologies. In order to provide such communication services, a communication channel is secured between a PSS (Portable Subscriber Station) of each user, such as a cellular phone, a PDA, or a laptop computer, and an RAS. Then, the PSS can use various communication services via the communication channel.

The RAS is connected to an ACR, which is connected to an NMS (Network Management System), the NMS manages the wireless network and relevant elements at the request of a service provider who provides various services (e.g. voice communication, wireless Internet). Particularly, the NMS stores all processors that are executed in lower elements (ACR, RAS) as files, transmits the processors to the lower elements during initial booting or rebooting of the wireless network, receives condition information from the elements, and manages the information.

The wireless network has a vertical network structure. More particularly, the NMS is connected to a number of ACRs, each of which is connected to a number of RASs. This means that, during initial booting or rebooting of the system, those of the processors stored in the NMS that are to be executed in the RASs are transmitted to the corresponding RASs via the ACRs.

As a result, the ACRs must download not only processors that are to be executed by themselves, but also processors of the lower RASs from the NMS. Combined with the fact that each ACR is connected to a number of RASs, this substantially lengthens the processor download time. Furthermore, the data transmission time is also prolonged because every condition information must be collected from the RASs and then transmitted to the NMS.

In summary, such a vertical network structure has a problem in that the multistage processor loading procedure lengthens the loading time, a complicated load program must be used to download the processors, and restarting of an upper processor requires that all lower processors are downloaded again. These problems frequently interrupt the wireless telecommunication service.

If an RAS has an error, its condition information is transmitted to the NMS via a corresponding ACR. This means that the NMS cannot receive information regarding the erroneous RAS until a long time elapses. A similar problem occurs when subsequent measures need to be taken. As a result, users cannot expect stable services.

### DISCLOSURE OF INVENTION

### Technical Problem

Therefore, the present invention has been made in view of the above-mentioned problems, and the present invention provides an interface for interfacing an element management server in a wireless telecommunication system and a method for the same, wherein an element management server for managing an ACR and an RAS are provided in the wireless telecommunication system and are adapted to interwork with the ACR and the RAS, respectively, so that the server can directly manage the ACR and the RAS and, particularly, the RAS can be operated more efficiently and maintained/repaired more quickly.

The present invention also provides an interface for interfacing an element management server in a wireless telecommunication system and a method for the same, wherein the element management server manages the version of a package regarding all processors of lower elements (e.g. ACRs, RASs) and software to be loaded, and respective processors of the ACRs and RASs store nothing but setup information (e.g. software, version) so that, if necessary, the element management server can transmit specific software to the ACRs and RASs, thereby guaranteeing fast download of software to be executed in the processors.

Furthermore, the present invention provides an interface for interfacing an element management server in a wireless telecommunication system and a method for the same, wherein restarting of an upper processor does not require that software executed in lower processors be downloaded again, thereby providing users with continuous services.

In addition, the present invention provides an interface for interfacing an element management server in a wireless telecommunication system and a method for the same, wherein software executed in a specific processor can be downloaded even if the wireless telecommunication system is operated, thereby improving the efficiency of operation of the wireless telecommunication system.

### Technical Solution

In accordance with an aspect of the present invention, there is provided an interface for interfacing an element management server adapted to manage an ACR (Access Control Router) and an RAS (Radio Access System) in a wireless telecommunication system, the interface including an ACR management interface for transmitting a first processor information request message for checking a software package version of a processor executed in the ACR and a first condition information request message for checking a condition of the ACR and receiving response messages; an RAS management interface for transmitting a second processor information request message for checking software package versions of an RAS management processor and a lower processor executed in the RAS and a second condition information request message for checking a condition of the RAS and receiving response messages; an ACR data interface for transmitting requested software data to the ACR and receiving condition information data regarding the ACR; and an RAS data interface for transmitting requested software data to the RAS and receiving condition information data regarding the RAS.

In accordance with an aspect of the present invention, there is provided a server for managing elements in a wireless telecommunication system, the server comprising: a first OAM management block having a function block for conducting at least one function of operation, administration, and maintenance of elements; an element interface block, which is connected to the first OAM management block, for transmitting messages for conducting at least one function of operation, administration, and maintenance of the elements to the elements and receiving response messages; and a data interface block for transmitting data requested from the elements to corresponding elements, receiving data regarding at least one function of operation, administration, and maintenance of respective elements, and transmitting the data to the first OAM management block, wherein the elements includes the ACR and the RAS, the ACR and the RAS directly connected to the server.

In accordance with an aspect of the present invention, there is provided a method for interfacing an element management server in a wireless telecommunication system, the method comprising the steps of: a) receiving first setup information containing an MAC address of an additional RAS from an element management client by the element management server; b) creating second setup information containing the MAC address of the additional RAS and an IP address of the element management server based on the first setup information and transmitting the second setup information to an ACR supposed to manage the additional RAS; c) receiving an IP address of the additional RAS from the ACR; d) receiving a PLD (Programmable Loading Data) file containing operation parameter information and a message requesting download of software of a processor from the additional RAS, the message being transmitted based on the IP address of the element management server contained in fourth setup information transmitted by the ACR; and e) transmitting the PLD file and the software of the processor to the additional RAS based on the IP address of the additional RAS.

### ADVANTAGEOUS EFFECTS

According to the present invention, the element management server in a wireless telecommunication system interworks with a lower element, particularly an RAS, and directly manages it. This improves the efficiency of management and operation of lower elements (e.g. RASs), guarantees quick maintenance/repair of lower elements, and provides stable services.

The element management system manages the package version information of all software executed in lower elements (e.g. ACRs, RASs), and processors mounted on the lower elements manage nothing but programs to be executed by themselves, as well as the version information, so that they have only to download necessary software from the element management system and restart it. This enables the download of a specific processor even if the wireless telecommunication system is operated.

Therefore, the present invention improves the efficiency of operation of the wireless telecommunication system and provides users with stable services.

### BRIEF DESCRIPTION OF THE DRAWINGS

The foregoing and other objects, features and advantages of the present invention will become more apparent from the following detailed description when taken in conjunction with the accompanying drawings in which:

FIG. 1 shows the layered structure of a wireless telecommunication system according to an embodiment of the present invention;

FIG. 2 shows an element management path of an EMS server according to an embodiment of the present invention;

FIG. 3 shows the structure of an external interface between an EMS and elements in a wireless telecommunication system according to an embodiment of the present invention;

FIG. 4 is a detailed block diagram showing an interface setup between an EMS server and elements in a wireless telecommunication system according to an embodiment of the present invention;

FIG. 5 is a detailed block diagram showing an RAS as an element according to an embodiment of the present invention;

FIGS. 6 to 8 are flowcharts showing a method for downloading driving data during an interface setup between an EMS server and elements according to an embodiment of the present invention; and

FIG. 9 shows SNMP-based implementation of an interface between an EMS server and elements according to an embodiment of the present invention.

### MODE FOR THE INVENTION

Hereinafter, exemplary embodiments of the present invention will be described with reference to the accompanying drawings. The same elements will be designated by the same reference numerals all through the following description and drawings although they are shown in different drawings. Further, in the following description of the present invention, a detailed description of known functions and configurations incorporated herein will be omitted when it may make the subject matter of the present invention rather unclear.

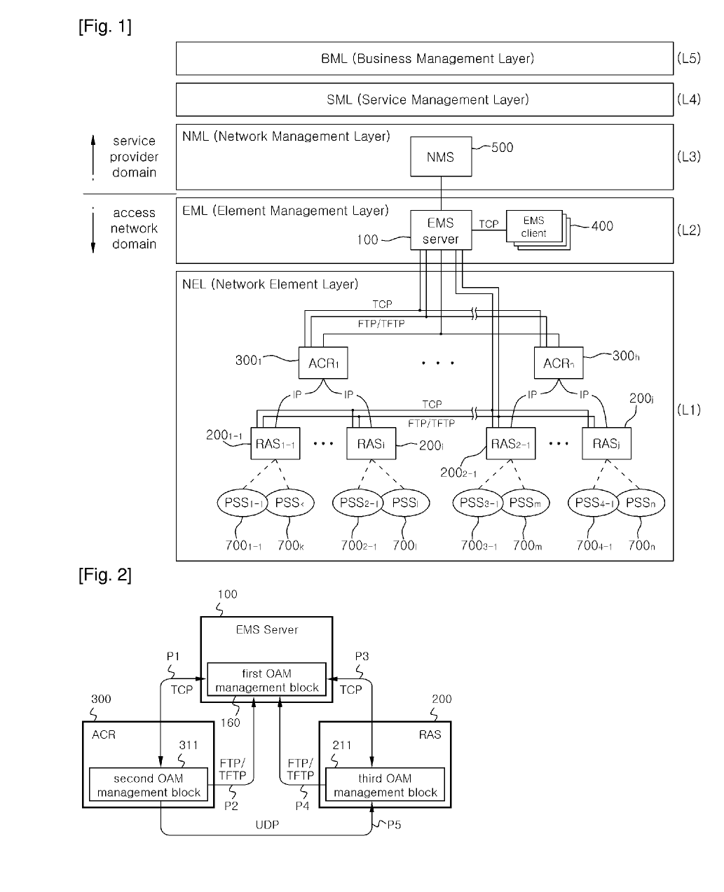

The layered structure of a wireless telecommunication system according to an embodiment of the present invention will now be described with reference to FIG. 1. The system includes an access network domain for setting up configurations for operating elements, managing wired/wireless resources, checking conditions, etc, and a service provider domain for managing services including mobile communication, wireless Internet, subscriber management, etc. The access network domain consists of an NEL (Network Element Layer) L1 and an EML (Element Management Layer) L2. The service provider domain consists of an NML (Network Management Layer) L3, an SML (Service Management Layer) IA, and a BML (Business Management Layer) L5.

The NEL L1 has elements positioned therein, including PSSs 700, RASs 200, and ACRs 300. The RASs 200 and the ACRs 300 are directly connected to an EMS (Element Management System) server 100 in the EML L2. The EMS server 100 is connected to an EMS client 400, which manages the EMS server 100 and the elements (i.e. the RASs 200 and the ACRs 300).

The PSSs 700 perform functions for wirelessly accessing portable Internet, accessing IP-based services, supporting IP mobility, authenticating and securing portable stations/users, receiving multicast services, interworking with other networks, etc. The RASs 200 perform functions for wirelessly accessing portable Internet, managing and controlling wireless resources, supporting mobility (handoff), guaranteeing authenticity and security, managing service quality, conducting downlink multicast, creating and providing information regarding accounting and statistics, etc. The ACRs 300 perform functions for managing IP routing and mobility, guaranteeing authenticity and security, managing service quality, providing accounting servers with accounting services, controlling mobility among RASs within ACRs, managing and controlling resources, etc.

The EMS server 100 is adapted to operate and maintain the RASs 200 and the ACRs 300. The EMS server 100 performs functions for download, element management, condition management, error management, test and diagnosis, statistics management, OSS (Operation Support System) matching, etc. The EMS server 100 communicates with the elements via a public network or an IP network dedicated to business providers. The EMS server 100 interworks with an NMS (Network Management System) 500 or the OSS of the service provider so that they are operated as a whole.

The communication between the EMS server 100 and the elements is based on TCP, SNMP, or FTP/TFTP (i.e. in-band communication). Out-band communication is also provided as a direction connection in case of an emergency (e.g. malfunctioning). The out-band connection with the RASs 200 is made via a debug port that can be directly connected to equipment and operated. The out-band connection with the ACRs 300 is a remote connection bypassing the EMS server 100 (e.g. Telnet client). Such an out-band connection requires its own authentication processing. In addition, the connection condition and the processing result must be reported to the EMS server 100 immediately.

The RASs 200 incorporate functions for initializing and restarting, monitoring processor blocks and restarting processors, and upgrading software during an operation. Based on operation parameters downloaded from the EMS server 100, the RASs 200 set up and operate their own configuration information and various operation parameters. If related information is changed, the EMS server 200 notifies the EMS server 100 of the change in real time. In addition, the RASs 200 manage image files and configuration files processor by processor.

The RASs 200 have layer-structured internal processors. Particularly, the highest processor, i.e. RMP (RAS Management Processor), manages lower processors, and each system has its PLD (Programmable Loading Data). The highest processor transmits messages containing parameters to lower processors via ICP (Inter Processor Communication).

The layered structure of processors guarantees that, even if the ACRs 300 are operated, the RASs 200 can be initialized.

FIG. 2 shows an element management path of an EMS server according to an embodiment of the present invention. A first OAM (Operations, Administration, Maintenance) management block 160 of the EMS server 100 interworks with a second OAM management block 311 of an ACR 300 and with a third OAM management block 211 of an RAS 200 so as to conduct functions necessary for the overall operation of the wireless telecommunication system (particularly, portable Internet), including the operation, administration, and maintenance of the corresponding elements (i.e. RAS 200 and ACR 300).

The first and second OAM management blocks 160 and 311 transmit/receive request/response messages for the operation, administration, and maintenance of the ACR 300 via a first path P1 directly connecting them to each other. The first OAM management block 160 receives information regarding errors and conditions of the ACR 300 from the second OAM management block 311 via the first path P1. The second OAM management block 311 transmits data (e.g. statistics files, operation setup information files) to the first OAM management block 160 via a second path P2 directly connecting them to each other.

The first and third OAM management blocks 160 and 211 transmit/receive request/response messages for the operation, administration, and maintenance of the RAS 200 via a third path P3 directly connecting them to each other. The first OAM management block 160 receives information regarding errors and conditions of the RAS 200 from the third OAM management block 211 via the third path P3. The third OAM management block 211 transmits data (e.g. statistics files, operation setup information files) to the first OAM management block 160 via a fourth path P4 directly connecting them to each other. The second OAM management block 311 manages the condition of the RAS 200 via a fifth path P5.

Preferably, the first and third paths P1 and P3 are adapted for TCP communication so that messages can be transmitted/received efficiently, the second and fourth paths P2 and P4 are adapted for FTP/TFTP communication so that large-capacity data (e.g. statistics data) and event data can be transmitted, and the fifth path P5 is adapted for UDP communication for the purpose of control and condition management of the RAS 200.

The information provided by the second OAM management block 311 and/or the third OAM management block 211 to the first OAM management block 160 always conforms to the actual condition of the RAS 200 and the ACR 300 through data transmission and matching processes. Similarly, the information used by the ACR 300 for control and condition management of the RAS 200 via the fifth path P5 is provided to the EMS server 100 in real time so that the information matches with data managed by the first OAM management block 160 to the third OAM management block 211.

If the third OAM management block 211 of the RAS 200 and the second OAM management block 311 of the ACR 300 fail to provide information requested by the first OAM management block 160 of the EMS server 100 due to errors or other reasons, they retransmit corresponding information at the request of the first OAM management block 160.

Information regarding various configurations necessary for interworking between the EMS server 100 and the RAS 200 and the ACR 300 is designated based on configuration files, and the first OAM management block 160 to the third OAM management block 211 are managed in the same manner as other processor blocks for the purpose of the interworking.

In summary, according to the present embodiment, the first OAM management block 160 of the EMS server 100 is directly connected to the second OAM management block 311 of the ACR 300 and the third OAM management block 211 of the RAS 200 for interworking so that, in addition to operation, administration, and maintenance of the ACR 300 and the RAS 200, information regarding errors and conditions of the ACR 300 and the RAS 200 can be collected and managed.

Respective elements and the EMS server, which are adapted for the functions described with reference to FIGS. 1 and 2, will now be described in more detail.

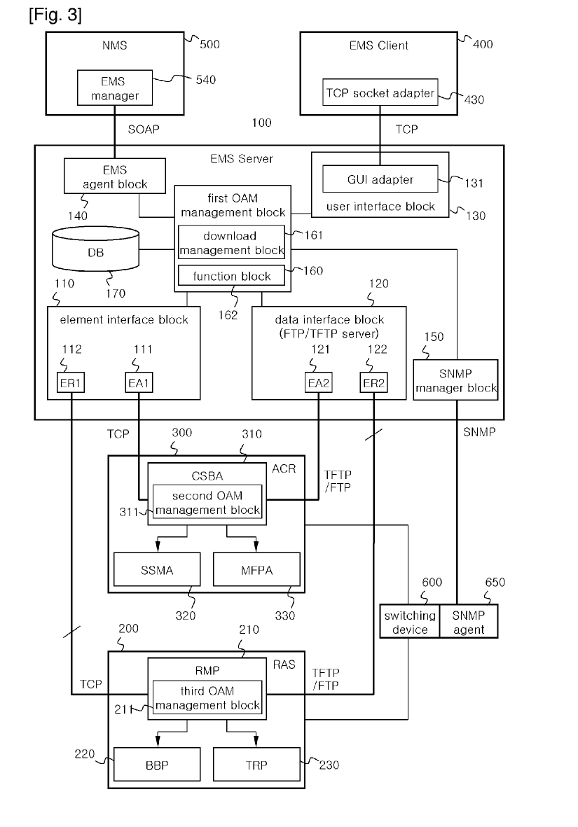

FIG. 3 shows the detailed structure of the network domain shown in FIG. 1. Particularly, FIG. 3 shows an exemplary interface between the EMS server 100 in the EML L2 and the elements.

One of the elements, the RAS 200, includes an MCCU (Main Control and Clock Unit), a DCCU (Digital Channel Card Unit), and a TRXU (Transceiver Unit).

The MCCU contains an RMP 210 and a GPS receiver/clock distributor (not shown). The RMP 210 is in charge of call processing blocks and performs functions for collecting and reporting information regarding communication, control, errors, conditions, and statistics related to lower blocks. The RMP 210 includes a loading block for downloading software for processors performing the above-mentioned functions. The GPS receiver/clock distributor receives clock-related signals from satellites, synchronizes them, and distributes them to lower blocks in order to operate a portable Internet system requiring accurate synchronization. The MCCU may be operated in dual modes (active and standby). The RMP 210 includes the third OAM management block 211 shown in FIG. 2.

The DCCU is equipped with a BBP (BaseBand Processor) 220 for processing the MAC/PHY modem of the portable Internet system. The DCCU performs functions for randomizing data, coding/decoding convolution/convolution-turbo channels, interleaving, allocating sub-channels regarding FUSC/PUSC, etc. in order to process data transmission with regard to PSSs. The DCCU also supports the receiving diversity function for a repeater interface unit. The DCCU is connected to a transceiver unit and the repeater interface unit via a SerDes (Serial/Deserializer). The DCCU is connected to a main control/clock unit and a network interface switch unit via Ethernet so that data can be processed efficiently between the PSSs and the RAS.

The TRXU converts digital IF signals transmitted by the DCCU into RF signals and transmits them to an RPAU (RAS High Power Amplifier Unit). The TRXU converts RF signals received from an RFEU (RF Front-End Unit) into digital IF signals and transmits them to the DCCU. The TRXU is equipped with a TRP (Transceiver Processor) 230 for signal processing.

Another element, the ACR 300, includes a CSBA (Control Switch Board Assembly) 310, an SSMA (Subscriber Service Mobility Board Assembly) 320, and an MFPA (Multi-Function Packet Processing Board Assembly) 330.

The CSBA 310 consists of a main function module adapted for routing and switching regarding IP packets and a main control processor module for controlling the main function module. The SSMA 320 consists of a board performing functions for managing the interworking of the RAS 200 and the ACR 300 and sessions, and a main control processor for processing these functions. The MFPA 330 consists of a board for providing a user application function of the ACR 300 and a main control processor for processing this function. The CSBA 310 includes the second OAM management block 311 shown in FIG. 2.

The EMS server 100 includes an element interface block 110 for message transmission with regard to the elements, a data interface block 120 for files transmission with regard to the elements, and a first OAM management block 160 having a download management block 161 for managing the transmission of files and other function blocks 162. The data interface block 120 includes an FTP/TFTP server.

The element interface block 110 includes an ACR management interface (EA1) 111 for message transmission with regard to the ACR 300 and an RAS management interface (ER1) 112 for message transmission with regard to the RAS 200. The data interface block 120 includes an ACR data interface (EA2) 121 for file transmission with regard to the ACR 300 and an RAS data interface (ER2) 122 for file transmission with regard to the RAS 200. In addition to the download management block 161, the function blocks 162 include a configuration management block, an error management block, a test/diagnosis block, a performance monitoring block, a statistics management block, a batch command processing block, a system resource management block, etc. Those skilled in the art can variously modify the construction and functionality of the function blocks 162 as desired.

In order to prevent traffic concentration during file transmission, a number of FTP/TFTP servers are provided in addition to the EMS server 100, and messages containing access information regarding the FTP/TFTP servers are transmitted to the elements during file transmission so that data can be divided and transmitted.

The EMS server 100 also includes a user interface block 130 having a GUI adapter 131 for transmitting and broadcasting commands of a number of clients with regard to a TCP socket adapter 430 of the EMS client 400, an EMS agent block 140 for SOAP communication with an EMS manager 540 of the NMS 500, and an SNMP manager block 150 connected to an SNP agent 650 of a switching device 600.

The above-mentioned ACR management interface 111 and the RAS management interface 112 are preferably adapted for TCP (Transmission Control Protocol)-based IPC (Inter Processor Communication) in order to quickly transmit messages and prevent them from being lost. The ACR data interface 121 and the RAS data interface 122 are preferably adapted for FTP (File Transfer Protocol)/TFTP (Trivial FTP) communication in order to transmit programs and statistics data. Preferably, the GUI adapter 131 employs a GUI (Graphic User Interface) so that the EMS client 400 can request the EMS server 100 to modify the configuration of the elements, and information transmitted to the EMS client 400 in relation to the condition information regarding the elements is preferably outputted based on the GUI. The EMS agent block 140 is preferably adapted to communication based on SOAP (Simple Object Access Protocol), which is a communication protocol for calling data or services with regard to another computer based on XML (eXtensile Markup Language) and HTTP (HyperText Transfer Protocol).

The SNMP manager block 150 of the EMS server 100 can manage the elements (e.g. RAS 200 and ACR 300) via the switching device 600 by using SNMP, as shown in FIG. 9.

As used herein, the SNMP refers to a protocol enabling remote users to logically investigate or modify management information regarding elements of a communication network. A management application 101 for managing elements interworks with management objects 201 and 301 included in respective elements. The interface between an SNMP manager 102 of the EMS server 100 and SNMP agents 202 and 302 of the elements employs UDP/IP 103, 104, 203, 204, 303, and 304, and establishes a direction connection via network-dependent protocols 105, 205, and 305. The interface makes it possible to obtain condition information based on an MIB (Management Information Base), which defines objects (elements) to be managed, or to setup the configuration information.

Particularly, the SNMP manager 102 transmits requests (e.g. “Get, Get Next, Get Bulk, Set”) to the SNMP agents 202 and 302, which then transmit responses to the requests and messages (traps) regarding the occurrence of events (e.g. detection of malfunctioning devices, errors, alarms) to the SNMP manager 102. The messages transmitted between the SNMP manager 102 and the SNMP agents 202 and 302 follow the SNMP.

Meanwhile, the EMS server 100 manages the version of a package regarding all processors of lower elements (e.g. ACR 200 and RAS 300) and software to be loaded, and respective processors of the ACR 300 store nothing but their setup information (e.g. software, version).

The RMP 210 of the RAS 200 stores its own software, as well as software of lower processors, such as the BBP 220 and the TRP 230. The CSBA 310 of the ACR 300 stores information regarding the package version of software to be executed by itself, as well as information regarding the package version of software executed in the SSMA 320 and the MFPA 330. The PLD, including setup information regarding the package version of software to be executed in respective elements, is not limited in a specific manner, and can be modified as desired by those skilled in the art.

The EMS server 100 according to the present invention, which is constructed as mentioned above, checks the version of software of lower processors one by one during initialization or rebooting of the wireless telecommunication system, and transmits necessary software only. This makes it unnecessary to transmit software of all processors, and enables transmission of software of a specific processor even if the wireless telecommunication system is operated.

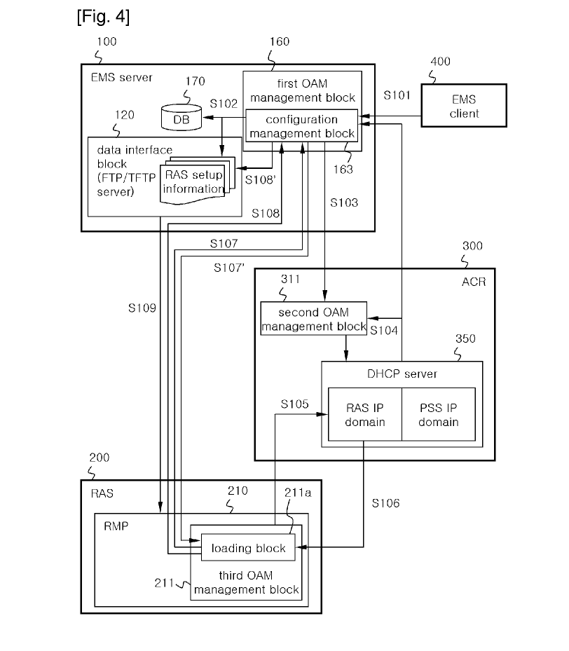

FIG. 4 is a block diagram showing a method for setting up an interface between the EMS server 100 and the RAS 200, particularly a method for setting up a new RAS 200 in the wireless telecommunication system.

The manner of adding a new RAS 200 has a varying registration procedure depending on the type of allocation of an IP address for the RAS necessary for IP communication between elements, e.g. whether it is static allocation of an IP address based on the operator's input or dynamic allocation of an IP address based on DHCP.

A procedure for registering a new RAS 200 by using a DHCP server 350 of the ACR 300, receiving a dynamically allocated IP address for the RAS 200, and adding the RAS 200, will now be described. The EMS client 400 transmits first setup information to the configuration management block 163 of the function blocks 160 included in the EMS server 100 (S101). The first setup information includes ID of the RAS of the RAS 200 to be newly registered, its MAC (Media Access Control) address, and PLD (e.g. package information, card installing information, cell operation parameters). The configuration management block 163 stores the transmitted first setup information on a database 170, creates a PLD file from the PLD, and transmits it to the data interface block 120 (S102). The configuration management block 163 extracts second setup information, including ID of the RAS necessary to setup the IP address of the RAS 200, its MAC address, and the IP address of the EMS server 100, from the first setup information and transmits it to the OAM management block 311 of the ACR 300 (S103).

The EMS server 100 includes processor blocks for processing information regarding the configuration of the RAS 200 and the ACR 300, error information, statistics information, test/diagnosis information, software download, batch command scheduling, etc. The second OAM management block 311 analyzes the received second setup information and adds a lower RAS 200 to the group of elements to be managed so that calls and IP packets can be processed with regard to the corresponding RAS 200. The second OAM management block 311 receives an allocated IP address regarding the RAS 200 from the IP area of the RAS of the DHCP (Dynamic Host Configuration Protocol) server 350, and transmits the IP address to the second OAM management block 311 and the EMS server 100 (S104).

A loading block 211a belonging to the third OAM management block 211 of the RMP 210 of the RAS 200 inputs third setup information, including the MAC address of the corresponding RAS 200, to the ACR 300 (S105). The DHCP server 350 of the ACR 300 then confirms if the MAC address included in the second setup information is equal to that included in the third setup information. If so, the DHCP server 350 transmits fourth setup information, including the IP address of the RAS 200 and that of the EMS server 100, to the loading block 211a of the RMP 210 (S106).

The loading block 211a of the RMP 210 of the RAS 200 transmits an initialization message to the EMS server 100 based on the IP address of the EMS server 100 included in the transmitted fourth setup information (S107). The loading block 211a obtains PLD file information, software file information, and the IP address necessary for data communication with the data interface block 120 (S107′). The loading block 211a requests the download of a PLD file and a software file from the first OAM management block 160 (S108). The data interface block 120 is requested to transmit the PLD file and the software file, which have been created in step S102, to the RMP 210 (S108′). The data interface block 120 transmits the PLD file and the software file, which have been created in step S102, to the RMP 210 (S109). The RMP 210 actuates the corresponding RAS 200 based on the transmitted PLD file. This completes the interface setup between the RAS 200 and the EMS server 100.

A procedure for setting up a new RAS used by the operator to input the IP address of the RAS 200 will now be described. After registering information regarding the RAS 200 on the EMS server 100, the operator can directly access the ACR 300 and the RAS 200 and set up the IP address. In this case, steps S103 to S106 shown in FIG. 2 are omitted. After being restarted, the RAS 200 transmits an initialization message to the EMS server 100, downloads its own driving data file and software file, and starts a service.

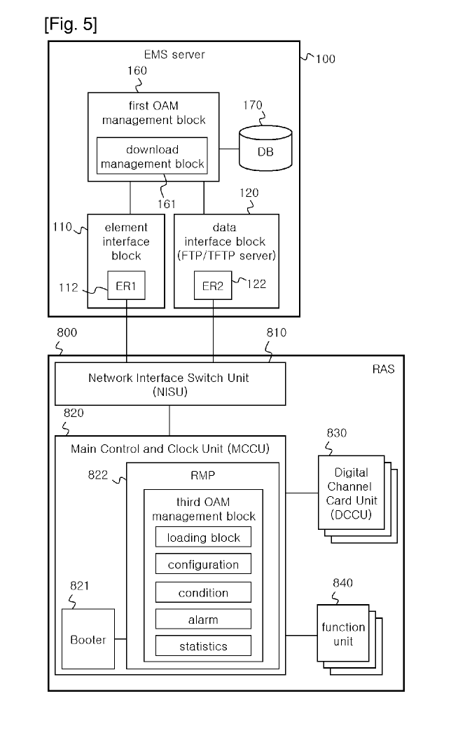

FIG. 5 is a detailed block diagram showing an RAS as an element according to an embodiment of the present invention. Although the RAS shown in FIG. 5 is given a reference numeral different from that shown in FIGS. 2 to 4, such a difference is intended for the ease of descriptions only, and the RAS has the same construction through these drawings.

The RAS 800 includes an NISU (Network Interface Switch Unit) 810, an MCCU (Main Clock and Clock Unit) 820, and a DCCU (Digital Channel Card Unit) 830. The NISU 810 has an Ethernet L2 switch for internal and external communication of the RAS 800, and provides an external Ethernet interface with regard to the RAS and an Ethernet interface with regard to other additional devices. The NISU 810 collects hardware alarms regarding lower blocks and reports them to the upper unit, i.e. the MCCU 820.

The RAS 800 further includes function units 840, such as a TRXU (Transceiver Unit), an RPAU (RAS High Power Amplifier Unit), an RFEU (RF Front-End Unit), and an RIFU (Repeater Interface Unit).

The MCCU 820 is equipped with a booter 821 for receiving PLD regarding the RAS 800 and an RMP 822 for managing the RAS 800. The RMP 822 includes a third OAM management block, which includes a number of processor blocks (e.g. loading blocks) for processing configuration setup, condition checkup, alarm checkup, statistics information, etc.

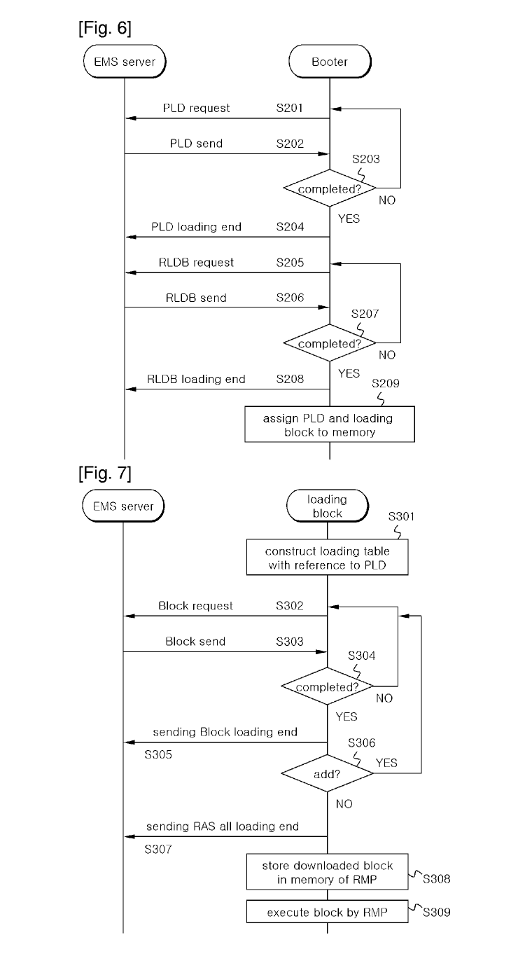

A method for downloading driving data by the RAS 800, which is constructed as mentioned above, according to an embodiment of the present invention will now be describe in more detail with reference to FIGS. 6 to 8.

As shown in FIG. 6, the booter 821 of the MCCU 820 of the RAS 800 transmits a PLD request to the EMS server 100 via the NISU 810 (S201). The EMS server 100 then transmits the PLD regarding the corresponding RAS 800 (S202). If transmission of the PLD is completed (S203), the booter 821 informs the EMS server 100 that transmission of the PLD has been completed (S204).

The booter 821 requests the EMS server 100 to provide a loading block (S205). The EMS server 100 transmits a loading block for the corresponding RAS 200 as requested by the booter 821 (S206). If transmission of the loading block is completed (S207), the booter 821 informs the EMS server 100 that transmission of the loading block has been completed (S208).

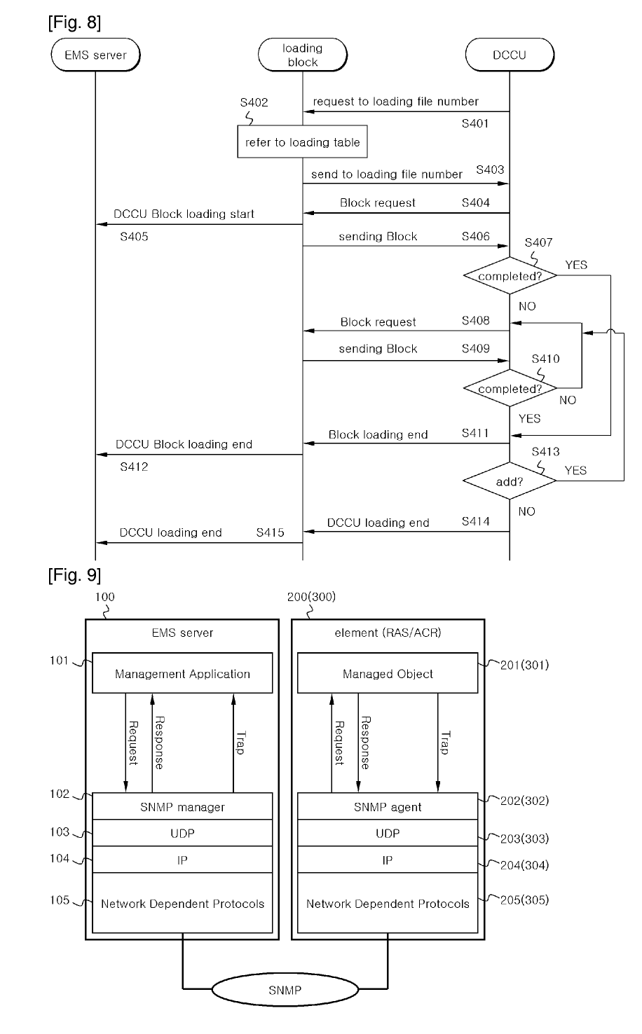

The booter 821 assigns an area for the transmitted PLD and operation parameter information to the internal memory of the RMP 822, and stores them (S209). After this process is over, the booter 821 employs the loading block to download a software block (abbreviated as a block in FIGS. 7 and 8) to be executed in the RMP 822.

As shown in FIG. 7, the loading block assigned and stored inside the RMP 822 constructs a software block loading table with reference to the PLD (S301), and requests the download of corresponding software blocks from the EMS server 100 (S302). The EMS server 100 then transmits the corresponding software blocks to the loading block (S303). If the download of the corresponding software blocks is completed (S304), the loading block informs the EMS server 100 of the completion (S305).

If there are additional software blocks to be downloaded (S306), the above process is repeated to download all necessary software blocks. If there is no additional software blocks to be downloaded (S306), the loading block informs the EMS server 100 that all software blocks have been downloaded (S307).

After all software blocks to be executed in the RAS 800 are completely downloaded in this manner, the loading block stores the downloaded software blocks in the internal memory of the RMP 822 (S308). After the blocks have been stored, the RMP 822 executes the software blocks (S309) so that predetermined functions are conducted.

In order to provide a service (e.g. mobile communication, wireless Internet) to the PSS 700 by the RAS 800, the DCCU 830 shown in FIG. 5 must process data transmission. Particularly, the DCCU 830 must download software blocks of the BBP as shown in FIG. 8.

To this end, the DCCU 830 requests the loading block to provide the number of files to be downloaded by itself (S401). The loading block then refers to the loading table (S402), and transmits the number of files to the DCCU 830 (S403).

Then, the DCCU 830 requests transmission of software blocks for a data transceiver processor (S404). The loading block informs the EMS server 100 that the DCCU 830 has started downloading software blocks for the data transceiver processor (S405), and transmits corresponding files to the DCCU 830 (S406).

If the download of corresponding software blocks is completed (S407), the DCCU 830 informs the loading block of the completion (S411). The loading block then informs the EMS server 100 of the completion (S412).

The DCCU 830 repeats these steps S408-S410 until all software blocks for the data transceiver processors are downloaded. After downloading all software blocks for the data transceiver processor (S413), the DCCU 830 informs the loading block of the completion (S414). The loading block then informs the EMS server 100 of the completion (S415).

Then, the DCCU 830 uses the downloaded data transceiver processor to provide the PSSs with a service (e.g. mobile communication, wireless Internet).

As shown in FIGS. 6 to 8, downloaded software and the package version information regarding the corresponding software are managed after being stored in the EMS server 100 and the processor executing each software. The EMS server 100 continuously checks information regarding the package of software for the processor and the package version of software stored inside each processor. If the package version of software stored in the EMS 100 is higher, the EMS 100 only transmits the package file of the corresponding software to a processor executing the corresponding software. This makes it possible to download nothing but software executed in a specific processor.

While the invention has been shown and described with reference to certain exemplary embodiments thereof, it will be understood by those skilled in the art that various changes in form and details may be made therein without departing from the spirit and scope of the invention. Therefore, the spirit and scope of the present invention must be defined not by described embodiments thereof but by the appended claims and equivalents of the appended claims.

1. An interface for interfacing an element management server adapted to manage an ACR (Access Control Router) and an RAS (Radio Access System) in a wireless telecommunication system, the interface comprising:
an ACR management interface for transmitting a first processor information request message for checking a software package version of a processor executed in the ACR and a first condition information request message for checking a condition of the ACR and receiving response messages;
an RAS management interface for transmitting a second processor information request message for checking software package versions of an RAS management processor and a lower processor executed in the RAS and a second condition information request message for checking a condition of the RAS and receiving response messages;
an ACR data interface for transmitting requested software data to the ACR and receiving condition information data regarding the ACR; and
an RAS data interface for transmitting requested software data to the RAS and receiving condition information data regarding the RAS.

2. The interface as claimed in claim 1, wherein the ACR management interface and the RAS management interface are adapted for IPC (Inter Processor Communication) based on TCP (Transmission Control Protocol).

3. The interface as claimed in claim 1, wherein the ACR data interface and the RAS data interface are adapted to transmit/receive data based on FTP/TFTP (File Transfer Protocol/Trivial FTP).

4. The interface as claimed in claim 1, further comprising a user interface for receiving commands for controlling the ACR and the RAS, and requesting condition information from an element management client connected to the element management server and transmitting results of the commands.

5. The interface as claimed in claim 4, wherein the user interface comprises a GUI (Graphical User Interface).

6. The interface as claimed in claim 1, wherein the element management server has an SNMP manager block for controlling and monitoring a switching device adapted to switch a network between the ACR and the RAS.

7. The interface as claimed in claim 6, wherein the network management interface is adapted to communicate based on SNMP (Simple Network Management Protocol).

8. The interface as claimed in claim 1, further comprising an EMS agent block for transmitting/receiving data to/from a network management system connected to the element management server.

9. The interface as claimed in claim 8, wherein the EMS agent block is adapted to communicate based on SOAP (Simple Object Access Protocol).

10. A server for managing elements in a wireless telecommunication system, the server comprising:
a first OAM management block having a function block for conducting at least one function of operation, administration, and maintenance of elements;
an element interface block, which is connected to the first OAM management block, for transmitting messages for conducting at least one function of operation, administration, and maintenance of the elements to the elements and receiving response messages; and
a data interface block for transmitting data requested from the elements to corresponding elements, receiving data regarding at least one function of operation, administration, and maintenance of respective elements, and transmitting the data to the first OAM management block,
wherein the elements includes the ACR and the RAS, the ACR and the RAS directly connected to the server.

11. The server as claimed in claim 10, wherein the ACR comprises a second OAM management block for conducting at least one function of operation, administration, and maintenance of the ACR while interworking with the first OAM management block.

12. The server as claimed in claim 11, wherein the first OAM management block is adapted to transmit/receive at least one message of request/response messages for operation, administration, and maintenance of the ACR via a first path leading to the ACR and to transmit/receive data to/from the ACR via a second path leading to the ACR.

13. The server as claimed in claim 10, wherein the RAS comprises a third OAM management block for conducting at least one function of operation, administration, and maintenance of the RAS while interworking with the first OAM management block.

14. The server as claimed in claim 13, wherein the first OAM management block is adapted to transmit/receive at least one message of request/response messages for operation, administration, and maintenance of the RAS via a third path leading to the RAS and to transmit/receive data to/from the RAS via a fourth path leading to the RAS.

15. The server as claimed in claim 12, wherein the message is transmitted/received based on TCP communication, and the data is transmitted/received based on FTP/TFTP communication.

16. The server as claimed in claim 10, wherein the first OAM management block for managing errors of the elements by making an out-band connection with the elements via a switching device.

17. The server as claimed in claim 16, further comprising an SNMP management block detecting errors of the elements by making an out-band connection with the elements.

18. The server as claimed in claim 10, wherein the first OAM management block comprises a function block for managing condition information and error information regarding the elements.

19. A method for interfacing an element management server in a wireless telecommunication system, the method comprising the steps of:
a) receiving first setup information containing an MAC address of an additional RAS from an element management client by the element management server;
b) creating second setup information containing the MAC address of the additional RAS and an IP address of the element management server based on the first setup information and transmitting the second setup information to an ACR supposed to manage the additional RAS;
c) receiving an IP address of the additional RAS from the ACR;
d) receiving a PLD (Programmable Loading Data) file containing operation parameter information and a message requesting download of software of a processor from the additional RAS, the message being transmitted based on the IP address of the element management server contained in fourth setup information transmitted by the ACR; and
e) transmitting the PLD file and the software of the processor to the additional RAS based on the IP address of the additional RAS.

20. The method as claimed in claim 19, wherein the element management server is directly connected to the ACR and the RAS.

21. The method as claimed in claim 19, wherein the first setup information further comprises ID of the RAS and the operation parameter information.

22. The method as claimed in claim 20, wherein the second setup information further comprises ID of the RAS.

23. The method as claimed in claim 19, wherein, in step c) comprises the steps of:
adding the additional RAS to a group of elements to be managed by the ARC,
and assigning the IP address of the additional RAS by using the second setup information.

24. The method as claimed in claim 19, wherein transmission of the fourth setup information in step d) is conducted by receiving third setup information containing the MAC address of the additional RAS from the additional RAS by the ACR and, when the MAC address of the RAS contained in the third setup information transmitted by the additional RAS is equal to the MAC address of the additional RAS contained in the second setup information transmitted by the element management server, transmitting the fourth setup information containing the IP address of the RAS and the IP address of the element management server to the additional RAS.

25. A method for an element management server in a wireless telecommunication system, the method comprising the steps of:
a) transmitting the operation parameter information and the loading block to the RAS, in response to a request for operation parameter information and a loading block from an RAS directly connected to the element management server;
b) transmitting all corresponding software blocks to the RAS when the loading block is executed and the RAS requests the software blocks; and
c) receiving information from the loading block that the software blocks of a data transceiver processor are transmitted to a channel card.

26. The method as claimed in claim 25, wherein step a) comprises the steps of:
a-1) transmitting the operation parameter information regarding the RAS in response to a request for the operation parameter information from the RAS;
a-2) transmitting the loading block in response to a request for transmission of the loading block from the RAS; and
a-3) assigning an area of the operation parameter information and the loading block, and storing the operation parameter information and the loading block by the RAS.

27. The method as claimed in claim 25, wherein step b) comprises the steps of:
b-1) constructing a loading table regarding the software blocks based on the operation parameter information by the RAS;
b-2) receiving request of the software blocks from the loading block;
b-3) transmitting all requested software blocks to the RAS; and
b-4) assigning an area of the software blocks and storing the software blocks by the RAS.

28. The method as claimed in claim 25, wherein step c) comprises the steps of:
c-1) requesting, by the channel card of the RAS, the software blocks of a data transceiver processor to the loading block;
c-2) receiving information from the loading block that the software blocks of a data transceiver processor are transmitted to a channel card, wherein the loading block transmits all corresponding software blocks sequentially to the channel card;
c-3) requesting, by the channel card of the RAS, a termination of transmission of the software blocks to the loading block when the software blocks are transmitted; and
c-4) receiving information from the loading block that the software blocks of a data transceiver processor has transmitted to a channel card.

29. The method as claimed in claim 25, further comprising a step of:
d) loading the transmitted software blocks by the channel card of the RAS and executing the data transceiver processor.
